(19) United States
(12) Patent Application Publication
(10) Pub. No.: US 2026/0077537 A1
(43) Pub. Date: Mar. 19, 2026

(54) METHODS OF FORMING SINTERED ARTICLES AND ASSOCIATED ASSEMBLIES AND COMPONENTS

(71) Applicant: Battelle Energy Alliance, LLC, Idaho Falls, ID (US)

(72) Inventors: Michael J. Moorehead, Rigby, ID (US); Jorgen F. Rufner, Idaho Falls, ID (US); Arin S. Preston, Idaho Falls, ID (US)

(21) Appl. No.: 19/109,088

(22) PCT Filed: Sep. 6, 2023
(86) PCT No.: PCT/US2023/073565

§ 371 Date: Mar. 5, 2025

Related U.S. Application Data
(60) Provisional application No. 63/374,711, filed on Sep. 6, 2022.

(51) Int. Cl. B28B 3/08; B22F 3/03

(52) U.S. Cl. CPC B28B 3/086; B22F 3/03

(57) ABSTRACT

A method of forming an article includes placing a feed material and a filler material in one or more cavities of a die assembly of a sintering apparatus and applying heat and pressure across the feed material and the filler material to form one or more sintered articles comprising the feed material. A die assembly of the sintering apparatus includes an upper punch, a lower punch defining one or more first through holes, the one or more first through holes defining one or more first cavities configured to receive a feed material, and a die defining a second through hole configured to at least partially receive the upper punch and the lower punch, the second through hole and at least one of the upper punch and the lower punch defining a second cavity configured to receive a filler material.

### PRIORITY CLAIM

This application is a national phase entry under 35 U.S.C. § 371 of International Patent Application PCT/US2023/073565, filed Sep. 6, 2023, designating the United States of America and published as International Patent Publication WO 2024/054857 A1 on Mar. 14, 2024, which claims the benefit of the filing date of U.S. Provisional Patent Application Ser. No. 63/374,711, filed Sep. 6, 2022, for “PARALLELIZED ELECTRIC-FIELD-ASSISTED SINTERING,” the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

The disclosure relates generally to methods of forming articles and associated assemblies. In particular, the disclosure relates to methods of forming sintered articles and associated assemblies and components.

### BACKGROUND

Previous efforts for the high-throughput formation of articles include diffusion multiples, combinatorial thin films (CTFs), and additive manufacturing (e.g., direct energy deposition). However, these methods each have limitations such as small volume, limited compositional control (e.g., poor microstructural control), limited article size/thickness, nonuniform material composition, limited dimensional accuracy, low material efficiency (e.g., wasted materials), and slow synthesis speed. Formation of articles with EFAS/SPS tooling assemblies mitigates some of these limitations. However, conventional EFAS/SPS tooling is often limited to producing a single article, which results in low throughput and a limited scale of production. Other associated limitations with single-batch EFAS/SPS production include high tooling costs and increased energy consumption.

### DISCLOSURE

Embodiments of the disclosure include a method of forming an article. The method includes placing a feed material having a first sintering temperature in one or more cavities of a die assembly of an electric-field-assisted sintering apparatus. The method further includes placing a filler material having a second sintering temperature in at least one of the one or more cavities of the die assembly of the direct current sintering apparatus. The method also includes applying an electric current and a pressure to the feed material and the filler material to form one or more sintered articles including the feed material.

Other embodiments of the disclosure include a die assembly of an electric-field-assisted sintering apparatus. The dies assembly includes an upper punch and a lower punch. The lower punch includes an insert defining one or more first through holes and a spacer wherein the one or more first through holes and an upper surface of the spacer define one or more first cavities configured to receive a feed material. The die assembly further includes a die defining a second through hole configured to at least partially receive the upper punch and the lower punch, the second through hole and at least one of the upper punch and the lower punch defining a second cavity configured to receive a filler material.

Another embodiment of the disclosure includes a die assembly of an electric-field-assisted sintering apparatus. The die assembly includes a lower punch and an upper punch. At least one of the lower punch and the upper punch include one or more features defining one or more first cavities configured to receive a feed material. The die assembly further includes a die defining a through hole configured to at least partially receive the lower punch and the upper punch, the lower punch, the upper punch, and the die together defining a second cavity configured to receive a filler material.

### BRIEF DESCRIPTION OF THE DRAWINGS

FIG. 1 is a schematic view of an SPS tooling assembly according to one or more embodiments of the disclosure.

FIG. 2 is a partial cross-sectional perspective view of a die assembly according to embodiments of the disclosure.

FIG. 3 is an exploded perspective view of a die assembly according to embodiments of the disclosure.

FIG. 4 is a perspective view of a lower punch of the die assembly of FIG. 3.

FIG. 5 is a cross-sectional perspective view of the lower punch of FIG. 4 taken along reference line 5.

FIG. 6A is a perspective view of a sintered article on a substrate formed by the die assembly of FIG. 3.

FIG. 6B is a cross-sectional perspective view of the sintered article on a substrate of FIG. 6A taken along reference line 6.

FIGS. 7A through 7D are cross-sectional elevational views of the lower punch and die of the die assembly of FIG. 3 taken along reference line 7 with various alternative material configurations for forming a sintered article on a substrate.

FIG. 8 is a perspective view of discrete sintered articles formed by the die assembly of FIG. 3.

FIGS. 9A through 9B are cross-sectional elevational views of the lower punch and die of the die assembly of FIG. 3 taken along reference line 7 with alternative material arrangements for forming discrete sintered articles.

FIG. 10 is a perspective view of a lower punch of a die assembly according to embodiments of the disclosure.

FIG. 11 is a cross-sectional perspective view of the lower punch of FIG. 10 taken along reference line 11.

FIG. 12A is a perspective view of a sintered article formed by a die assembly according to embodiments of the disclosure.

FIG. 12B is a cross-sectional perspective view of the sintered article of FIG. 12A taken along reference line 12B.

FIG. 13 is an exploded view of a die assembly according to embodiments of the disclosure.

FIG. 14 is a perspective view of an insert of the die assembly of FIG. 13.

FIG. 15 is a cross-sectional perspective view of the insert of FIG. 14 taken along reference line 15.

FIG. 16 is a cross-sectional elevational view of the lower punch and die of the die assembly of FIG. 13 taken along reference line 16.

FIG. 17 is an exploded view of a die assembly according to embodiments of the disclosure.

FIG. 18 is a perspective view of the insert of the die assembly of FIG. 17.

FIG. 19 is a cross-sectional perspective view of the insert of FIG. 18 taken along reference line 19.

FIG. 20 is a cross-sectional perspective view of the insert of FIG. 18 taken along reference line 19 with plungers of the die assembly of FIG. 17 positioned in through holes of the insert.

FIG. 21 is a cross-sectional elevational view of the lower punch and die of the die assembly of FIG. 17 taken along reference line 21.

FIG. 22 is a perspective view of an insert according to embodiments of the disclosure.

FIG. 23 is a cross-sectional perspective view of the insert of FIG. 22 taken along reference line 23.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

As used herein, the terms “spark plasma sintering (SPS)” and “electrical field assisted sintering (EFAS)” are equivalent terms that may be used interchangeably. Although the term “spark plasma sintering” includes the word “plasma,” a plasma material may or may not be used or generated in the SPS process.

As used herein, the term “feed material” means and includes a solid material not yet at a desired densified (e.g., sintered) state. The feed material may comprise a loose (e.g., flowable) solid powder, solid particles, solid flakes, or other solid masses of small sizes, such as metal powders or ceramic powders. The feed material may have previously been subjected to sintering (e.g., partial sintering) without yet having formed a sintered article exhibiting a desired density.

Bulk high-throughput formation of articles with varying material compositions is commonly sought after in many manufacturing and testing applications. Examples of desired articles include discrete articles of varying material compositions and arrays of articles formed on a substrate material.

Embodiments of the disclosure include die assemblies and methods for forming sintered articles on a substrate and discrete sintered articles. The die assemblies may be configured for use with a sintering tooling assembly (e.g., an EFAS/SPS tooling assembly). In some embodiments, the die assembly may be configured to produce at least one sintered article formed on a substrate. In other embodiments, the die assembly may be configured to produce at least one discrete sintered article without the inclusion of a substrate. The die assemblies may facilitate the formation of the sintered article with one or more features or through holes.

An EFAS/SPS tooling assembly, is configured to form the sintered articles of varying material compositions or varying sizes and/or shapes in a single process. Using powders as a feed material, the sintered (e.g., dense) articles of varying chemical compositions and varying sizes and/or shapes may be produced simultaneously (e.g., substantially simultaneously). The sintered articles may include sintered articles produced as separate (e.g., discrete) sintered articles in a single batch (e.g., a single sintering process) or multiple sintered articles on a substrate. Embodiments of the disclosure may be used to produce multiple sintered articles for manufacturing production or research processes. The embodiments of the disclosure may greatly accelerate production rates of the sintered articles by producing multiple sintered articles in parallel, reduce tooling costs, reduce the amount of production time, and save energy.

SPS presents a viable alternative to conventional processes for forming sintered articles (e.g., material compositions) in testing and manufacturing applications. SPS processes, according to embodiments of the disclosure, may utilize far fewer acts and lower costs compared to conventional processes. For example, compared to conventional processes, the SPS processes of embodiments of the disclosure may facilitate improved compositional control, high material efficiency (e.g., reduced material waste), high dimensional accuracy, and increased synthesis speed (e.g., facilitating a greater throughput over a given time period).

SPS processes, in accordance with embodiments of the disclosure, involve applying a combination of pressure and electrical current (e.g., pulsed or unpulsed direct current (DC) or alternating current (AC)) to a “feed” material in a controlled environment (e.g., an environment in which pressure and temperature are controllable) to form a sintered article. The application of the electrical current generates heat internally within the feed material. In some embodiments, external heat is also applied to the feed material within the controlled environment.

The electrical current applied during the SPS process, according to embodiments of the disclosed processes, may range from about 0 amps (A) to about 150,000 A, such as from about 10,000 A to about 140,000 A, from about 20,000 A to about 130,000 A, from about 30,000 A to about 120,000 A, from about 40,000 A to about 110,000 A, or from about 50,000 A to about 100,000 A. The electrical current may be applied (e.g., applied directly) to a die containing (e.g., holding) the feed material during the SPS process.

In some embodiments, the electrical current is applied by subjecting the feed material, and the die, to an applied electric field. The applied electric field may be greater than or equal to about 4 V/cm (e.g., from about 4 V/cm to about 20 V/cm).

The feed material may include unprocessed powders or flakes of a desired material composition or previously sintered components. The particles of the feed material may include a single particle size or a distribution of particle sizes, such as a multimodal distribution of particle sizes. For example, the feed material may comprise, consist essentially of, or consist of particles of substantially consistent size or may be provided as a mixture of different particle sizes, which may minimize formation of pores in the sintered article. With multiple particle sizes, smaller particles (e.g., smaller flakes) may function to fill in what would otherwise be voids in the interstitial spaces between larger particles (e.g., larger flakes).

An EFAS/SPS tooling assembly includes a die assembly including a die, an upper punch, and a lower punch. The die is configured as a large cylindrical component made of graphite or other material that exhibits a high melting temperature and/or high sintering temperature. The die includes a through hole bored between a flat top surface and a flat bottom surface thereof. The upper punch and the lower punch are configured to be received by the through hole of the die. Together, the die, the upper punch and the lower punch define a cavity for receiving the feed material. The SPS process applies pressure and an electrical current to the die assembly and the feed material within the cavity. The applied pressure and electrical current heats the feed material in the cavity to above a sintering temperature of the feed material to densify the feed material and form a resulting sintered article.

One or more of the punches (e.g., the lower punch and/or the upper punch) may include one or more features (e.g., cavities, protrusions, through holes, or combinations thereof) of various shapes and sizes. The shape and size of the features may be selected depending on the article to be formed. The features may be filled with the feed material exhibiting the chemical composition of the one or more desired articles. The die assembly is then subjected to a sintering process. The feed materials in the features are sintered substantially simultaneously (e.g., in parallel) to densify the feed materials and form one or more loose sintered articles or an array of sintered articles sintered on a single substrate.

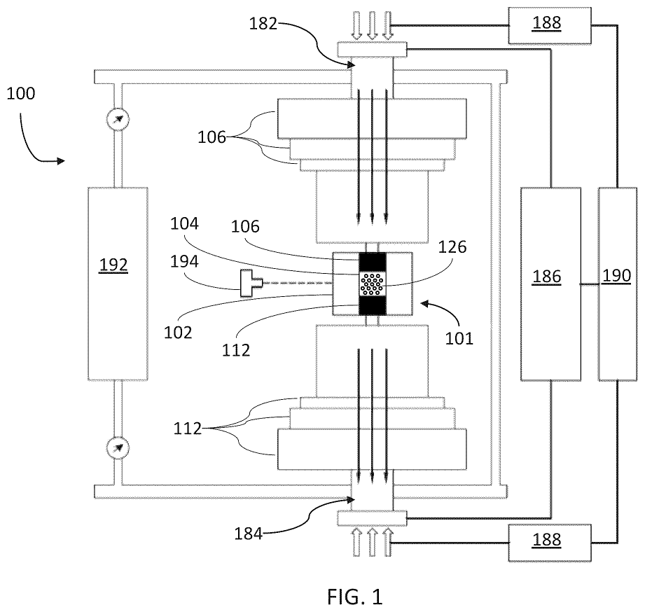

An SPS tooling assembly 100 is shown in FIG. 1. The SPS tooling assembly 100 is configured to apply pressure and an electrical current across a feed material 126 in a die assembly 101. By applying the electrical current and pressure, one or more of the temperature, pressure, and electrical current may be adjusted during the material sintering process. The die assembly 101 is coupled to the SPS tooling assembly 100 and defines one or more cavities configured to receive the feed material 126 to be sintered. The feed material 126 may include multiple feed materials 126 having different (e.g., varying) material compositions or may be a single feed material 126. The die assembly 101 includes a die 102 having an interior surface 104 partially defining a cavity for receiving the feed material 126 and/or a filler material (not shown in FIG. 1). The die 102 may be formed of a material with a high sintering temperature (e.g., graphite), such as a material having a sintering temperature greater than a sintering temperature of the feed material 126. The feed material 126 is positioned within the die 102 between an upper punch 106 and a lower punch 112 of the SPS tooling assembly 100.

The SPS tooling assembly 100 is configured to apply an electric current to the die assembly 101, through the upper punch 106, the lower punch 112, and across the feed material 126, heating the feed material 126. The magnitude of electric current applied to the die assembly 101 and consequently, across the feed material 126, depends on the desired temperature to which the feed material 126 is to be heated. The SPS process, in accordance with embodiments of the disclosure, uses the electric current to heat the feed material 126 by so-called “Joule Heating.” The magnitude of electric current may be selected depending on the properties of the feed material 126, the geometry of the die 102, the geometry of the upper punch 106, the geometry of the lower punch 112, and the amount of feed material 126 to be sintered. The upper punch 106 and the lower punch 112 may include a substantially similar cross-sectional shape and size as one another.

The SPS tooling assembly 100 may include an upper electrode 182 electrically coupled to the upper punch 106 (e.g., soldered to or in contact with a top surface 110 of the upper punch 106) and a lower electrode 184 electrically coupled to the lower punch 112 (e.g., soldered to or in contact with a bottom surface 118 of the lower punch 112) for conducting the electric current through the upper punch 106 and lower punch 112. The electric current may be applied to one of the upper punch 106 and the lower punch 112, flow through the upper punch 106 or lower punch 112, through the feed material, and out of the other of the upper punch 106 and the lower punch 112.

The electric current applied to the upper and lower electrodes 182, 184 may be initiated by the current controller 186. The electric current applied to the punch (e.g., upper punch 106, lower punch 112) may range from about 1240 amps (A) to about 150,000 A, such as from about 1240 A to about 150,000 A, from about 20,000 A to about 130,000 A, from about 30,000 A to about 120,000 A, from about 40,000 A to about 110,000 A, or from about 50,000 A to about 100,000 A. The magnitude of electric current applied corresponds to a fabrication temperature during the SPS process.

The fabrication temperature may include one or more of a temperature of a punch material, a temperature of a die material, or a temperature of the feed material 126. The fabrication temperature generated by the applied electric current may depend on the resistivity and the thickness of the material of the punch (e.g., upper punch 106, lower punch 112), the geometry of the punch (e.g., upper punch 106, lower punch 112), the geometry of the die 102, the material of the die 102, and the material composition of the feed material 126. In some embodiments, the fabrication temperature is between about 200° C. to about 3000° C., such as from about 200° C. to about 600° C., from about 600° C. to about 1200° C., about 1000° C. to about 2000° C., or from about 2000° C. to about 2600° C. The feed material 126 may include, but is not limited to a metal, a ceramic, a cermet, a metal oxide, a transition metal, a refractory metal, or a combination thereof. The feed material 126 may exhibit a melting point within a range of from about 1000° C. to about 2000° C. In some embodiments, the feed material includes titanium, vanadium, chromium, manganese, iron, cobalt, copper, nickel, aluminum, tungsten, an alloy thereof, or a combination thereof.

After, or at substantially the same time as applying electrical current, the SPS tooling assembly 100 may apply pressure (e.g., compressive force) to the punch (e.g., upper punch 106, lower punch 112), and across the feed material 126 under constraint of the die assembly 101. The SPS tooling assembly 100 shown in FIG. 1 includes a mechanism for applying pressure, such as, a power-fluid system 188 (e.g., a pneumatic system or hydraulic system) coupled to the upper punch 106 and the lower punch 112. The power-fluid system 188 of the SPS tooling assembly 100 may apply pressure to the feed material 126 through the upper punch 106 and/or lower punch 112. The pressure applied by the upper punch 106 and the lower punch 212, respectively, may be from about 0 mega pascals (MPa) to greater than 100 MPa, such as from about 10 MPa to about 100 MPa, from about 15 MPa to about 90 MPa, from about 20 MPa to about 80 MPa, from about 25 MPa to about 70 MPa, from about 30 MPa to about 60 MPa, or from about 35 MPa to about 50 MPa. The acts of applying electric current to generate heat and applying pressure to the die assembly 101 and the feed material 126 include holding a substantially constant electric current and pressure for a pre-determined amount of time (e.g., hold time). The hold time may range from about 1 minute (min) to about 90 min, such as from about 1 min to about 60 min, from about 3 min to about 30 min, from about 4 min to about 20 min or about 5 min to about 15 min.

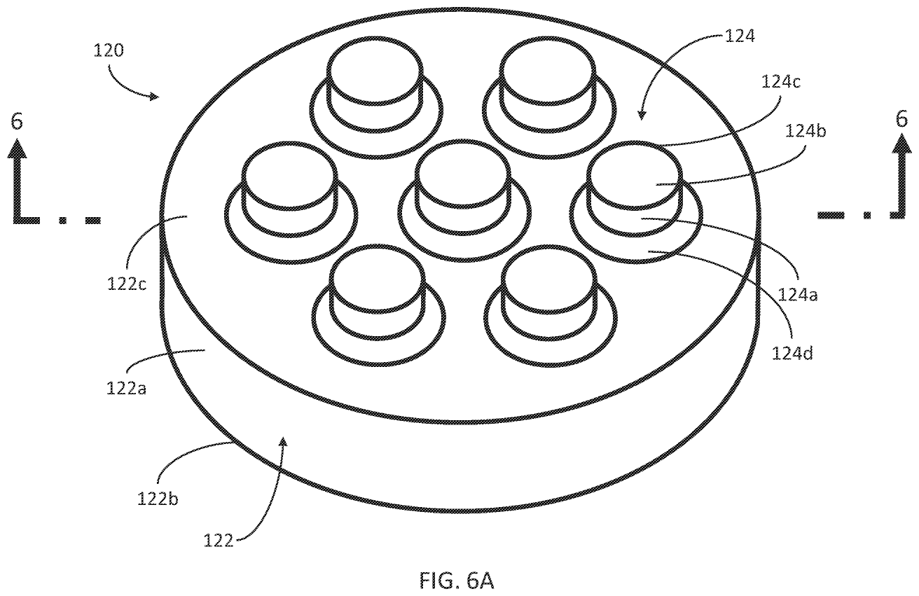

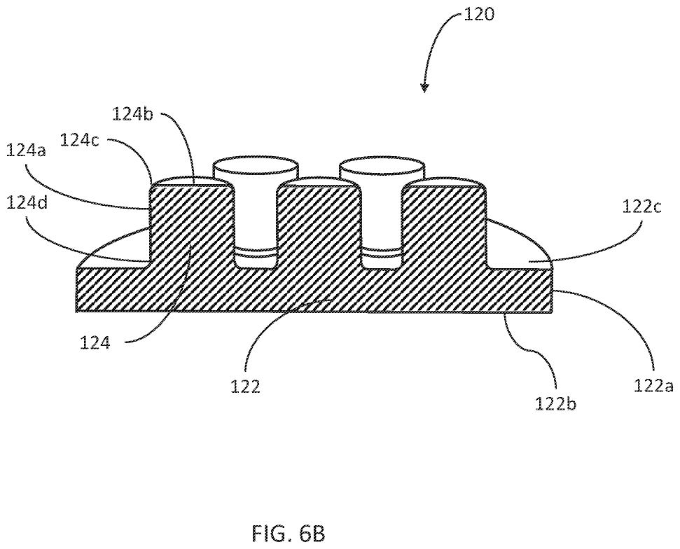

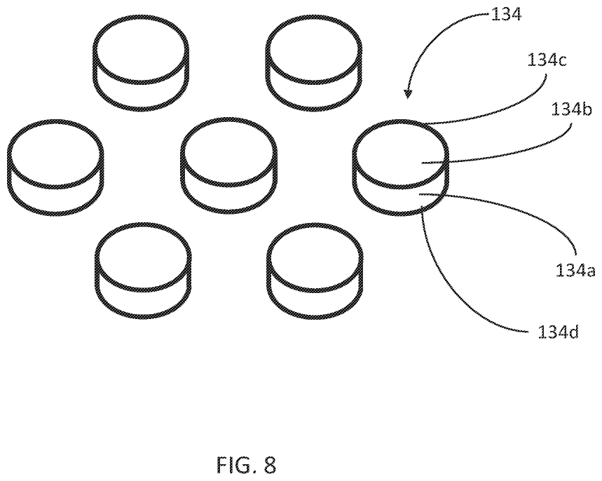

Additional processing parameters, such as bonding atmosphere, heating rate, and surface finish may be selected to achieve the desired material properties of the formed sintered array 120 (shown in FIG. 6A) or discrete sintered articles 134 (shown in FIG. 8). For example, the bonding atmosphere may include a vacuum, an argon atmosphere, or a helium atmosphere. For example, the heating rate may be in a range of from about 1° C. per minute (° C./min) to about 300° C./min, such as from about 10° C./min to about 250° C./min, from about 50° C./min to about 200° C./min, or from about 75° C./min to about 175° C./min. The heating may be monitored by a pyrometer 194 external to the die 102.

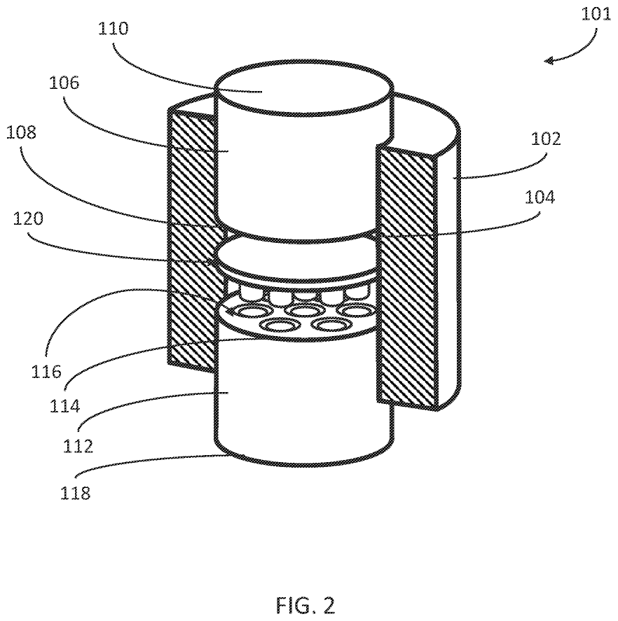

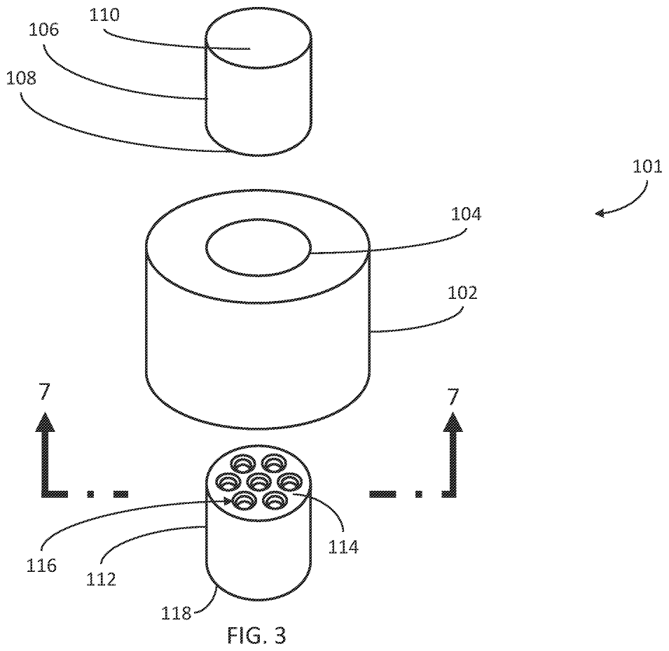

A cross section of the die 102 and the die assembly 101 is shown in FIG. 2, which is an exploded view of the die assembly 101 shown in FIG. 3. Referring to FIGS. 1 through 3, the application of electric current and pressure to the die assembly 101 containing the feed material 126, for a desired hold time, forms a sintered article. The application of both electric current and pressure may be controlled by the system controller 190, operably coupled to the current controller 186 and the power-fluid system 188. In preparation for the application of the electric current, and after the feed material 126 is placed in the die assembly 101, the SPS tooling assembly 100 may be evacuated and back filled with argon, helium, or another inert gas. The evacuated pressure may be in the range of from about 1×10⁻² Torr to about 1×10⁻³ Torr. The current and pressure are applied to the die assembly 101. After applying the electric current and applying the pressure, the sintered article is removed from the die assembly 101 of the SPS tooling assembly 100. The sintered article may be cooled by a cooling system 192 before removal or may cool slowly by dissipating heat to the surrounding environment.

Referring to FIGS. 2 and 3, the die 102, the lower punch 112, the upper punch 106 or a combination thereof may include one or more features 116 of varying sizes or shapes to facilitate the sintering of a sintered array 120 (shown in FIG. 6A) or discrete sintered articles 134 (shown in FIG. 8) in a single process. The features 116 may be formed by machining cavities of desired shapes and dimensions into a material of the lower punch 112. The die 102 includes an interior surface 104 partially defining a cavity for receiving feed material 126 (shown in FIG. 1). The cavity defined by the interior surface 104 is configured to partially receive the upper punch 106 and the lower punch 112. The punch (e.g., upper punch 106 and lower punch 112) includes surfaces (e.g., top surface 110, bottom surface 118) configured to interface with the SPS tooling assembly 100 of FIG. 1. The punch (e.g., upper punch 106 and lower punch 112) also includes surfaces (e.g., bottom surface 108, top surface 114) which, together with the interior surface 104 of the die 102, define one or more cavities for receiving the feed material 126. The top surface 114 of the lower punch 112, the bottom surface 108 of the upper punch 106, or a combination thereof may include one or more features 116 defining one or more first cavities configured to receive the feed material 126. The number and dimensions of the features 116 may vary depending on the sintered articles to be formed.

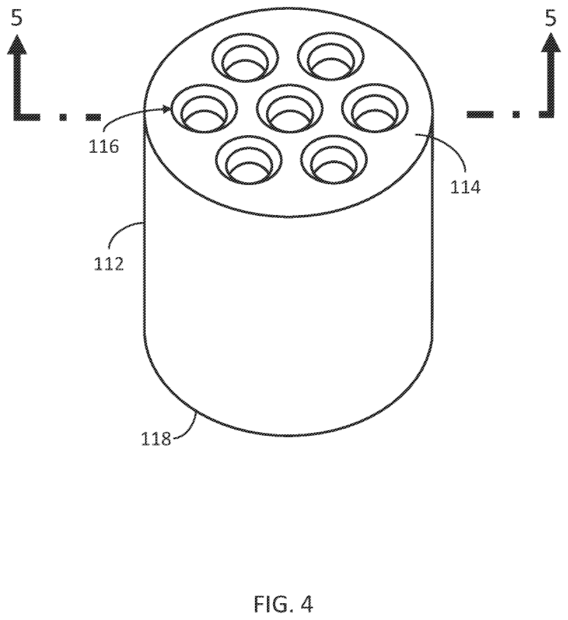

The top surface 114 of the lower punch 112, as shown in FIGS. 3 and 4, may include any number (e.g., 5, 7, or 31) of features 116. The features 116 of the lower punch 112 define one or more first cavities configured to receive the feed material 126. In some embodiments, the upper punch 106 includes features 116 substantially complimentary to (e.g., a negative image of) the features 116 of the lower punch 112.

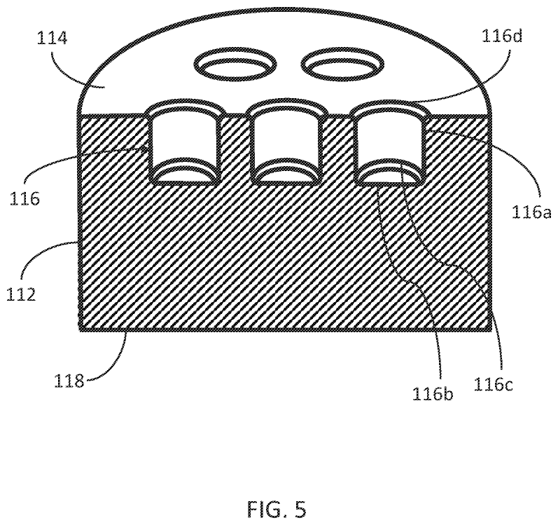

FIG. 5 is a perspective cross-sectional view of the lower punch 112 of FIG. 4 taken along reference line 5. The features 116 of the lower punch 112 may include an internal sidewall 116a defining, at least partially, a cavity for receiving feed material 126. The internal sidewall 116a of the features 116 may exhibit a substantially circular cross-sectional shape, a hexagonal shape, a pentagonal shape, a star shape, a triangular shape, a square shape, an arcuate shape, or a rectangular shape. The features 116 may also include a bottom surface 116b. The bottom surface 116b may be substantially planar or may include one or more internal features. For example, the bottom surface 116b may form a generally conical shape, a hemisphere shape, a cylindrical shape, a cross shape, a star shape, or other desired shape. The bottom surface 116b may include bottom edges 116c which contact a bottom portion of the internal sidewalls 116a. The bottom edges 116c may include a desired feature or shape. For example, the bottom edges 116c may include a chamfer or fillet to define rounded edges on the resulting sintered array 120 (shown in FIG. 6A) or discrete sintered articles 134 (shown in FIG. 8). Additionally, rounded or chamfered bottom edges 116c may facilitate easier removal of the sintered array 120 or discrete sintered articles 134. The features 116 may include additional features on a top edge 116d of the internal sidewall 116a. For example, the top edge 116d may include a chamfer or a fillet. A rounded or chamfered top edge 116d may facilitate easier loading of the feed material 126 into the features 116, easier removal of the sintered array 120 or discrete sintered articles 134 and provide increased strength for sintered articles 124 which are sintered onto a substrate 122 (see FIG. 6A) of the sintered array 120.

The sintered array 120, as shown in FIGS. 6A and 6B, may include a substrate 122 and one or more sintered articles 124 on the substrate 122. While FIG. 6A shows seven sintered articles 124 on the substrate 122, fewer or more sintered articles 124 may be present. In addition, while FIG. 6A shows equally spaced sintered articles 124, nonuniform spacings of the sintered articles 124 are possible. The shape and dimensions of the sintered article 124 substantially correspond to the shape and dimensions of the features 116 of the lower punch 112. In some embodiments, the sintered article 124 includes an external sidewall 124a, a top surface 124b, a top edge 124c, and a bottom edge 124d. The external sidewall 124a may exhibit a substantially circular cross-sectional shape, a hexagonal shape, a pentagonal shape, a star shape, a triangular shape, a square shape, an arcuate shape, or a rectangular shape. The top surface 124b may be substantially planar or may include one or more features mated to internal features of the features 116. For example, the top surface 124b may exhibit a generally conical shape, a hemisphere shape, a cylindrical shape, a cross shape, a star shape, or other desired shape. The top surface 124b includes top edges 124c which contact a top portion of the external sidewalls 124a. The top edge 124c may include a desired feature or shape. For example, the top edge 124c may include a chamfer or fillet. The bottom edge 124d of the external sidewall 124a may additionally include one or more features. For example, the bottom edge 124d may include a chamfer or a fillet. A rounded or chamfered bottom edge 124d may facilitate easier removal of the sintered array 120 and may provide increased strength for sintered articles 124 which are sintered onto a substrate 122. If multiple sintered articles 124 are present, adjacent sintered articles 124 may be separated from one another by material of the substrate 122. The sintered articles 124 may each be formed of the same material composition or of two or more different compositions. In other words, the material of the substrate 122 extends between adjacent sintered articles 124.

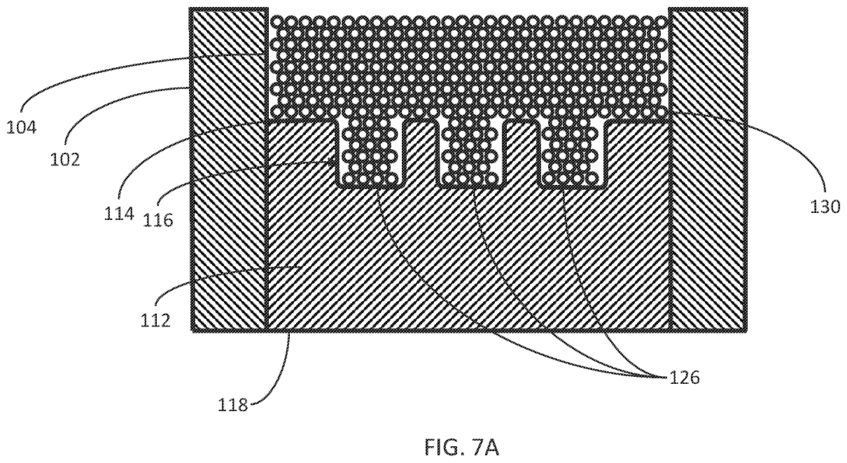

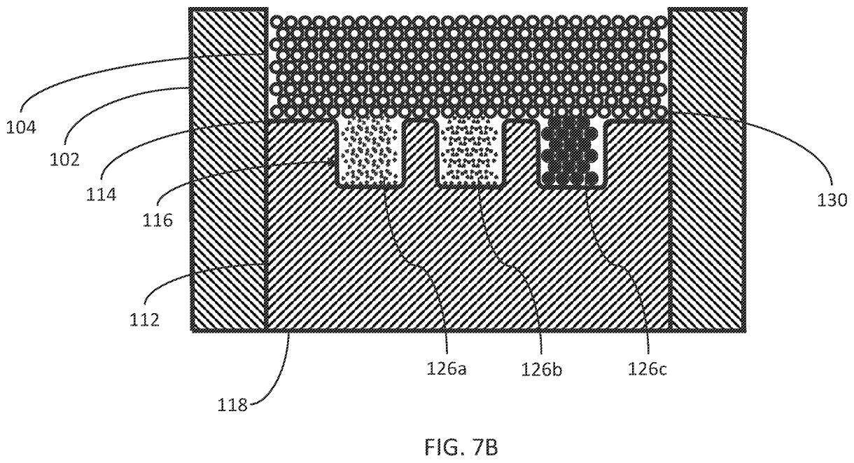

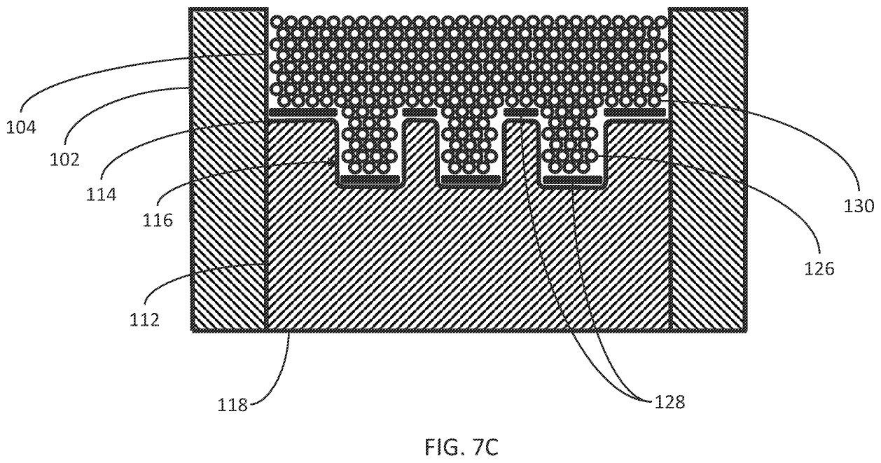

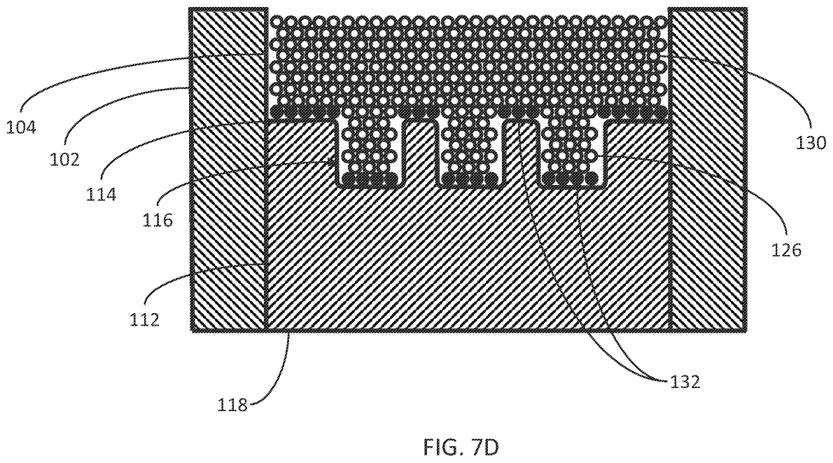

FIGS. 7A-7D depict various material arrangements for forming the sintered array 120 of FIGS. 6A and 6B to produce a desired material composition of the sintered array 120. For example, as described in further detail below, different combinations of feed material 126, filler material 130, foil inserts 128 (e.g., foil liners), and release agents 132 may impart different properties on the resulting sintered array 120. In the embodiments depicted in FIGS. 7A-7D, the difference between the sintering temperature of the feed material 126 and the sintering temperature of the filler material 130 is within a determined range (e.g., within a range of about 0° C. to about 500° C.) for the feed material 126 to sinter together with the filler material 130. In some embodiments, the filler material 130 is substantially the same material composition as the feed material 126.

FIGS. 7A-7D include elevational cross-sectional views of the lower punch 112 and the die 102 taken along reference line 7 of FIG. 3. As discussed below in reference to FIGS. 7A-7D, the die 102 and the lower punch 112 define one or more cavities configured to receive varying arrangements of the feed material 126, foil inserts 128, filler material 130, release agents 132, or a combination thereof within the cavities of the die assembly 101 for the formation of different sintered arrays 120 (shown in FIGS. 6A and 6B) with desired configurations of sintered articles 124 on the substrate 122.

The features 116 define one or more first cavities configured to receive the feed material 126. A second cavity is defined by the top surface 114 of the lower punch 112 and the interior surface of the die 102 and is configured to receive a filler material 130. The feed material 126 and the filler material 130 may have the same material composition as one another or different material compositions. The one or more first cavities and the second cavity are configured to receive feed material (e.g., 126, 126a, 126b, and 126c), foil insert 128, filler material 130, or a combination thereof. The filler material 130 may facilitate the transfer of pressure and/or electrical current from the punch (e.g., upper punch 106 and/or lower punch 112) and across the feed material 126. Additionally, the filler material 130 may deform during sintering to accommodate the densification properties of the feed material 126.

Referring to FIG. 7A, the one or more first cavities defined by the features 116 may be filled with feed material 126 and the second cavity defined by the top surface 114 of the lower punch 112 and the interior surface 104 of the die may be filled with a filler material 130. In FIG. 7A, the filler material 130 has the same material composition as the feed material 126. The material composition of the feed material 126 and filler material 130 may be substantially homogeneous. The feed material 126 and filler material 130 may be deposited into the first cavities and second cavity manually or may be automatically mixed, measured (e.g., weighed), and deposited by robotics or other equipment. Once deposited, the feed material 126, the filler material 130, and the die assembly 101 are subjected to a sintering process. The sintering process may include increasing the temperature of the feed material 126, filler material 130, the die assembly 101, or a combination thereof to a temperature higher than the sintering temperature of the feed material 126 and the filler material 130. Upon completion of the sintering process the feed material 126 and the filler material 130 may be sintered together, to form a sintered array 120 including sintered articles 124 and substrate 122 of the same material composition.

Referring to FIG. 7B, different compositions of feed material 126a, 126b, 126c may be used to form a sintered article having multiple sintered articles 124 each exhibiting a different material composition sintered onto the substrate 122. For example, each of the one or more first cavities defined by features 116 may be substantially filled with a feed material 126a, 126b, 126c exhibiting two or more different material compositions. Filler material 130 may be positioned within the second cavity on top of the feed materials 126a, 126b, and 126c. The feed material 126 and filler material 130 may be deposited manually or it may be automatically mixed, measured (e.g., weighed), and deposited by robotics or other equipment. Once deposited, the feed materials 126a, 126b, and 126c; the filler material 130; and the die assembly 101 are subjected to a sintering process. The sintering process may include increasing the temperature of the feed material 126, filler material 130, the die assembly 101, or a combination thereof to a temperature higher than the sintering temperature of the feed material 126a, 126b, and 126c and the filler material 130. Upon completion of the sintering process the feed material 126a, 126b, and 126c and the filler material 130 may be sintered together to form a sintered array 120. The resulting sintered array 120 includes one or more sintered articles 124 of varying material compositions sintered onto a substrate 122. For example, the sintered articles 124 may include one or more of titanium, vanadium, chromium, manganese, iron, cobalt, and nickel and the substrate 122 may include nickel. In some embodiments, the sintering temperature of the varying feed materials 126a, 126b, 126c and the sintering temperature of the filler material 130 used to form the substrate 122 are substantially similar. In other embodiments, the sintering temperature of the varying feed materials 126a, 126b, 126c and the sintering temperature of the filler material 130 are different from each other, such as differing within a range of from about 100° C. to about 500° C.

Referring to FIG. 7C, foil insert 128 may be inserted into the cavity defined by the lower punch 112 and the die 102. In some configurations, the foil insert 128 is inserted into the features 116, on the top surface 114, or a combination thereof to facilitate easier removal of the sintered array 120 from the die assembly 101. The foil insert 128 may be a graphite foil or foil of another material with a sintering temperature higher than the sintering temperature of the feed material 126. The feed material 126 and filler material 130 may be deposited manually or may be automatically mixed, measured (e.g., weighed), and deposited by robotics or other equipment. Once positioned in the one or more first cavities and the second cavity, the feed material 126, the filler material 130, foil insert 128 and die assembly 101 are subjected to a sintering process to form a sintered array 120 from the feed material 126 and/or the filler material 130. The sintering temperature of the foil insert 128 may be higher than the sintering temperature of the feed material 126 and the filler material 130, such as, for example, more than about 200° C. higher, more than about 300° C. higher, more than about 400° C. higher, or more than about 500° C. higher. The sintering process may include increasing the temperature of the feed material 126, filler material 130, foil insert 128, the die assembly 101, or a combination thereof to a temperature higher than the sintering temperature of the feed material 126 and the filler material 130 but lower than the sintering temperature of the foil insert 128. Upon completion of the sintering process the feed material 126 and the filler material 130 may be sintered together, forming a sintered array 120. The foil insert 128, which remains substantially unsintered, may facilitate easier removal of the sintered array 120.

Referring to FIG. 7D, a release agent 132 may be formed on a bottom surface of the one or more first cavities and on a bottom surface (e.g., the top surface 114 of the lower punch 112) of the second cavity defined by the lower punch 112 and the die 102 prior to depositing the feed material 126 and filler material 130. The release agent 132 may include a powder of a material (e.g., boron carbide, boron nitride, or graphite powder) with a higher sintering temperature than the feed material 126 and the filler material 130. For example, the difference in sintering temperature between the release agent 132 and the feed material 126 and/or the filler material 130 may be more than about 200° C., more than about 300° C., more than about 400° C., or more than about 500° C. Once deposited in the cavity, the feed material 126, filler material 130, the release agent 132, and die assembly 101 are subjected to a sintering process to form a sintered array 120 from the feed material 126 and the filler material 130. The sintering process includes increasing the temperature of the feed material 126, filler material 130, the release agent 132, and/or the die assembly 101 to a temperature higher than the sintering temperature of the feed material 126 and the filler material 130 but lower than a sintering temperature of the release agent 132. Upon completion of the sintering process the feed material 126 and the filler material 130 are sintered together to form a sintered array 120 and the release agent 132 remains substantially in powder form. Depositing the release agent 132 prior to depositing the feed material 126 and the filler material 130 may facilitate easier removal of the sintered array 120 from the die assembly 101.

FIG. 8 shows discrete sintered articles 134 formed as separate components without a substrate. The shape and dimensions of each discrete sintered article 134 is substantially defined by the shape and dimensions of a corresponding cavity defined by features 116 of the lower punch 112. In some embodiments, the discrete sintered article 134 includes an external sidewall 134a, a top surface 134b, a top edge 134c, and a bottom edge 134d. The external sidewall 134a may include a substantially circular cross section. The external sidewall 134a may include a cross section of various shapes (e.g., hexagonal, pentagonal, star-shaped, triangular, square, arcuate, or rectangular). In some embodiments, a punch (e.g., upper punch 106, lower punch 112, or a combination thereof) may include multiple features each having a desired geometry and or dimensions. The top surface 134b may be substantially flat or it may include one or more top features. For example, the top surface 134b may form a generally conical shape, a hemisphere, a recessed cylinder, a cross, a star, or may include other desired shapes or features. The top surface 134b includes top edges 134c which contact a top portion of the external sidewalls 134a. The top edge 134c may include a desired feature or shape. For example, the top edge 134c may include a chamfer or fillet. The bottom edge 134d of the external sidewall 134a may additionally include one or more features. For example, the bottom edge 134d may include a chamfer or a fillet.

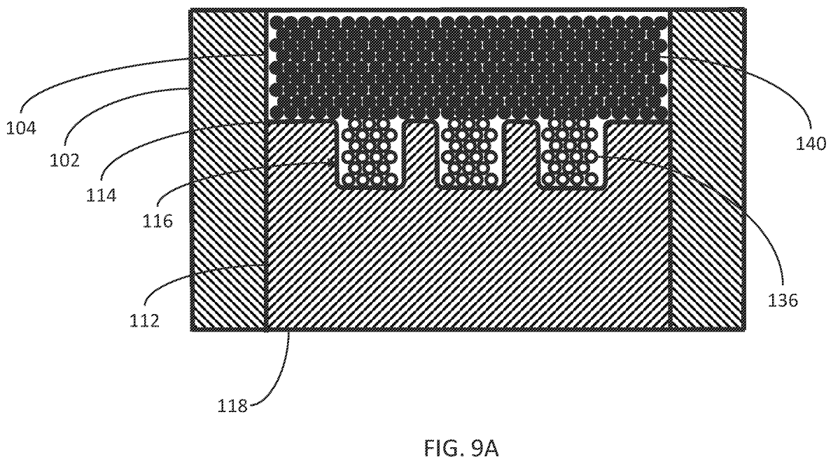

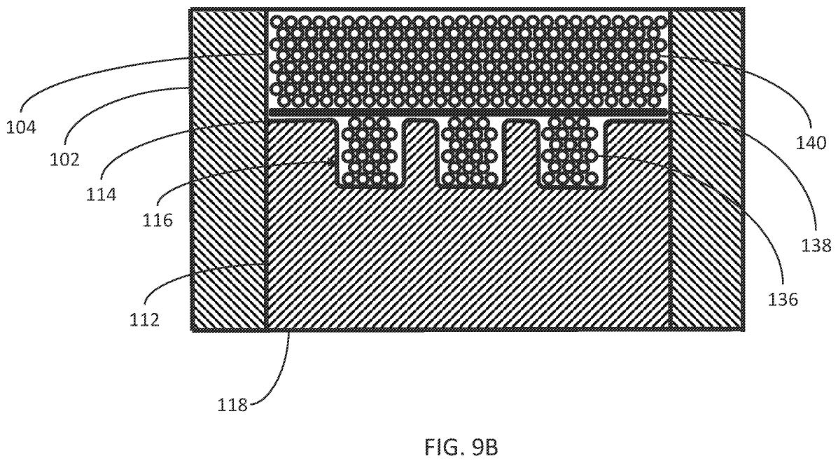

FIGS. 9A and 9B depict various configurations of feed material 136, filler material 140, foil inserts 128, and a release agent for the formation of discrete sintered articles 134 (shown in FIG. 8) without a substrate. For example, as described in further detail below, different combinations of feed material 136, filler material 140, foil inserts 138 (e.g., foil liners), and release agents (not shown) may impart different properties on the resulting discrete sintered articles 134. In the embodiments depicted in FIGS. 9A-9B, the filler material 140 may have a different material composition from the feed material 136 and/or the difference between the sintering temperature of the feed material 136 and the sintering temperature of the filler material 140 may be greater than a determined range (e.g., greater than about 200° C., about 300° C., about 400° C., or about 500° C.) to prevent the feed material 136 from sintering with the filler material 140.

FIGS. 9A-9B include elevational cross-sectional views of the lower punch 112 and the die 102 taken along reference line 7 of FIG. 3. As depicted in FIGS. 9A-9B, the die 102 and the lower punch 112 define one or more cavities configured to receive the feed material 136, foil insert 138, filler material 140, or a combination thereof for the formation of discrete sintered articles 134.

FIG. 9A illustrates an arrangement of the feed material 136 and filler material 140 within the one or more cavities of the die assembly 101 (shown in FIG. 3) for the formation of discrete sintered articles 134 (shown in FIG. 8) without a substrate. The features 116 of the lower punch 112 define one or more first cavities configured to receive feed material 136. The one or more cavities may be substantially filled with the feed material 136. The second cavity may be defined at least partially by the top surface 114 of the lower punch 112, and interior surface 104 of the die 102, and a top surface of the feed material 136. The filler material 140 may be deposited into the second cavity. A difference between the sintering temperature of the filler material 140 and the sintering temperature of the feed material 136 is sufficient (e.g., greater than about 200° C., about 300° C., about 400° C., or about 500° C.) for the feed material 136 to not sinter with the filler material 140. In some embodiments, the filler material 140 includes boron carbide or graphite powder. Once deposited in the cavity, the feed material 136, filler material 140, and die assembly 101 are subjected to a sintering process to form discrete sintered articles 134 without a substrate. The sintering process includes increasing the temperature of the feed material 136, filler material 140, and/or the die assembly 101 to a temperature higher than the sintering temperature of the feed material 136 but lower than a sintering temperature of the filler material 140. Upon completion of the sintering process the feed material 136 has sintered together to form discrete sintered articles 134 and the filler material 140 remains substantially in powder form. Accordingly, the discrete sintered articles 134 may be removed from the die assembly 101 and separated from the filler material 140 to form discrete sintered articles 134 without a substrate.

FIG. 9B illustrates a configuration of feed material 136, filler material 140, and foil insert 138 for the formation of discrete sintered articles 134 (shown in FIG. 8) without a substrate. The features 116 of the lower punch 112 define one or more first cavities configured to receive feed material 136. The one or more cavities may be substantially filled with the feed material 136. The second cavity may be defined at least partially by the top surface 114 of the lower punch 112, and interior surface 104 of the die 102, and a top surface of the feed material 136. The foil insert 138 may be positioned between the feed material 136 and the filler material 140. The filler material 140 may be deposited into the second cavity on top of the foil insert 138. A difference between the sintering temperature of the foil insert 138 and/or filler material 140 and the sintering temperature of the feed material 136 is sufficient (e.g., greater than about 200° C., about 300° C., about 400° C., or about 500° C.) for the feed material 136 to not sinter with the foil insert 138 and filler material 140. The sintering temperature of the foil insert 138 may be higher than the sintering temperature of the feed material 136, such as, for example, more than about 200° C. higher, more than about 300° C. higher, more than about 400° C. higher, or more than about 500° C. higher. In some embodiments, the foil insert 138 includes graphite foil. Once deposited in the cavity, the feed material 136, foil insert 138, filler material 140, and die assembly 101 are subjected to a sintering process to form discrete sintered articles 134 without a substrate. The sintering process includes increasing the temperature of the feed material 136, foil insert 138, filler material 140, and/or the die assembly 101 to a temperature higher than the sintering temperature of the feed material 136 but lower than a sintering temperature of foil insert 138 and/or the filler material 140. Upon completion of the sintering process the feed material 136 has sintered together to form discrete sintered articles 134 without sintering with the foil insert 138 and/or the filler material 140. Accordingly, the discrete sintered articles 134 may be removed from the die assembly 101 and separated from the filler material 140 to form discrete sintered articles 134 without a substrate.

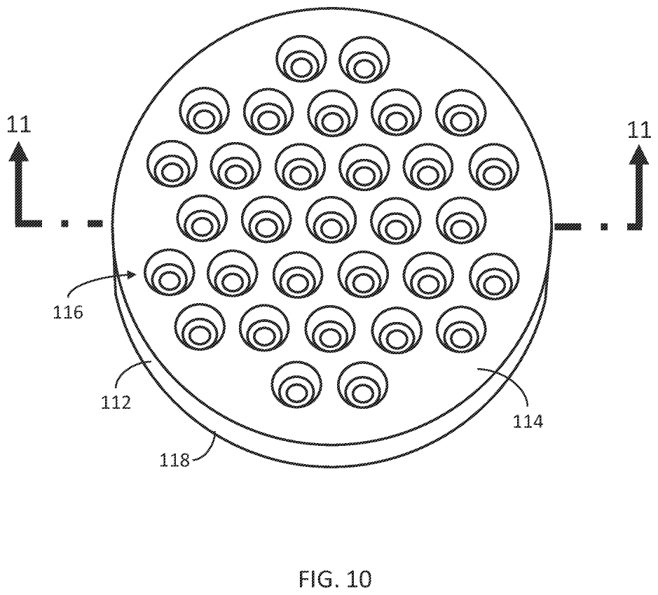

Referring to FIGS. 10-12B, the lower punch 112 may be configured to form a sintered array 120 including one or more sintered articles 124 having a depression 124e in a top surface 124b thereof. Sintered articles 124 with a depression 124e formed therein may be desirable for applications (e.g., molten salt corrosion testing and oxidation testing) where the depression 124e is desired to contain one or more substances (e.g., corrosive substances).

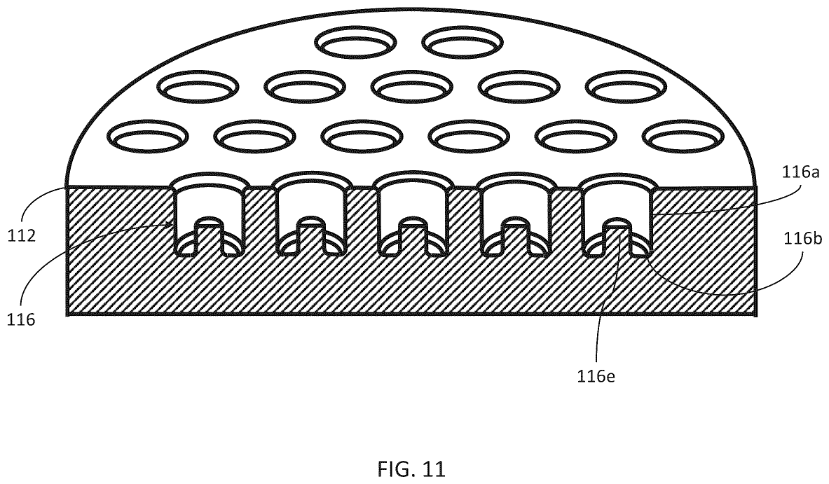

FIG. 11 is a perspective cross-sectional view of the lower punch of FIG. 10 taken along reference line 11. The lower punch of FIG. 11 includes features 116 with one or more sub features 116a, 116b, 116c, 116d. The features 116 includes an internal sidewall 116a at least partially defining a cavity for receiving feed material 126. The internal sidewall 116a of the features 116 may include a cross section of various shapes (e.g., circular, hexagonal, pentagonal, star-shaped, triangular, square, arcuate, or rectangular). The features 116 may also include a bottom surface 116b having an internal feature 116e extending therefrom. As illustrated, the internal feature 116e includes a protrusion extending upward into the cavity defined by the features 116 (e.g., to form a depression 124e (shown in FIG. 11) in the resulting sintered article 124). Alternatively, the internal feature 116e may be configured as a depression extending downward from the bottom surface 116b (e.g., to form a protrusion in the resulting sintered article 124). The internal feature 116e may include a cross section of various shapes (e.g., circular, hexagonal, pentagonal, star-shaped, triangular, square, arcuate, or rectangular). In some embodiments, the cross-sectional shape of the internal feature 116e is substantially similar to a cross-sectional shape of the internal sidewall 116a. In other embodiments, the cross-sectional shape of the internal feature 116e differs from the cross-sectional shape of the internal sidewall 116a.

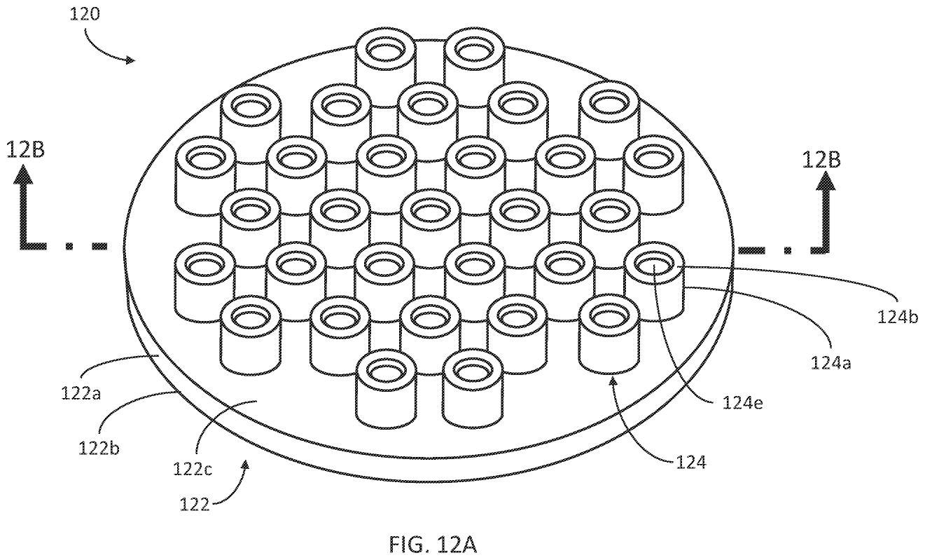

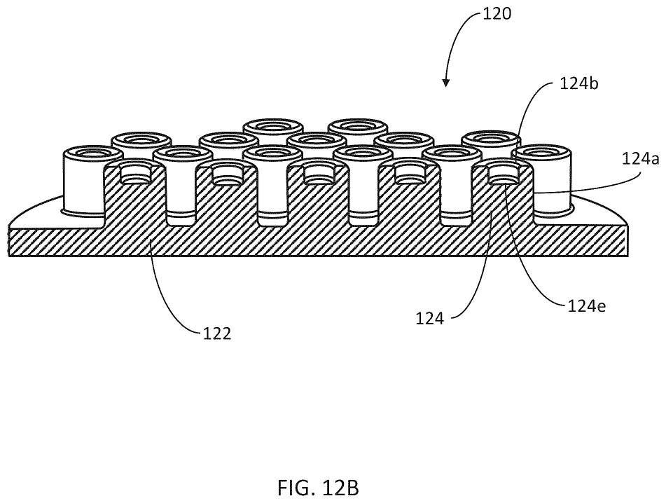

The sintered array 120, as shown in FIGS. 12A and 12B, formed from the lower punch illustrated in FIGS. 10-11 may include a substrate 122 and at least one sintered article 124 sintered onto a substrate 122. The sintered article 124 includes a depression 124e formed in a top surface 124b thereof. The shape and dimensions of the depression 124e are substantially mated to the shape and dimensions of the internal feature 116e of the lower punch 112 depicted in FIGS. 10-11. The depression 124e may include a substantially circular cross section. In other embodiments the depression 124e may include a cross section of various shapes (e.g., hexagonal, pentagonal, star-shaped, triangular, square, arcuate, or rectangular). In some embodiments, the cross-sectional shape of the depression 124e is substantially similar to a cross-sectional shape of the external sidewall 124a. In other embodiments, the cross-sectional shape of the depression 124e differs from the cross-sectional shape of the external sidewall 124a.

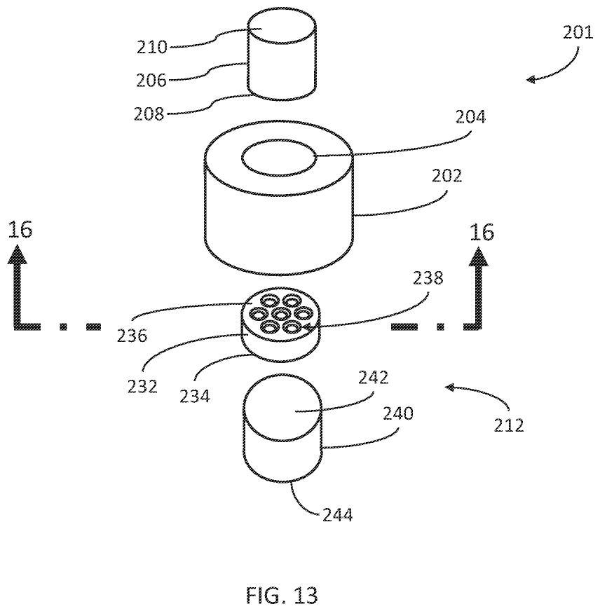

An exploded view of a die assembly 201 according to other embodiments of the disclosure is shown in FIG. 13. The die assembly 201 includes a lower punch 212 including an insert 232 and a spacer 240. The insert 232 may be a consumable article and configured for use for only a desired number of sintering processes (e.g., 1 process, 5 processes, 10 processes, or greater than 10 processes). Upon depletion of the insert 232, a new insert may be provided without the need to replace the spacer 240 or other components of the die assembly 201.

Die assembly 201 includes a die 202, an upper punch 206, and a lower punch 212 including an insert 232 and a spacer 240. The die 202 includes an interior surface 204 partially defining a cavity for receiving a feed material (e.g., feed material 126). The upper punch 206 includes a top surface 210 configured to interface with an SPS tooling assembly (e.g., SPS tooling assembly 100) and a bottom surface 208 partially defining one or more cavities for receiving a feed material (e.g., feed material 126). The spacer 240 includes a bottom surface 244 configured to interface with an SPS tooling assembly (e.g., SPS tooling assembly 100), and a top surface 242. In some embodiments, the spacer 240 includes a recess configured to receive a bottom portion of the insert 232 formed in the top surface 242 thereof. The top surface 242 of the lower punch 212 together with the one or more through holes 238 of the insert 232 define one or more cavities for receiving a feed material (e.g., feed material 126). In some embodiments, the top surface 242 of the spacer 240 is a substantially flat surface. The bottom surface 234 of the insert 232 may be coupled to the top surface 242 of the spacer 240 (e.g., using adhesives, welding, or mechanical fasteners).

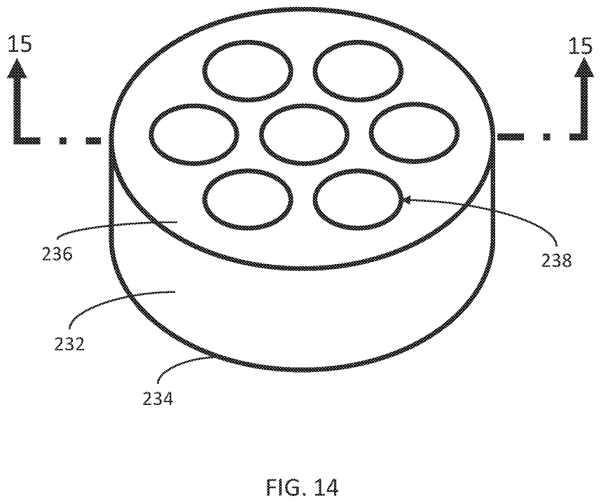

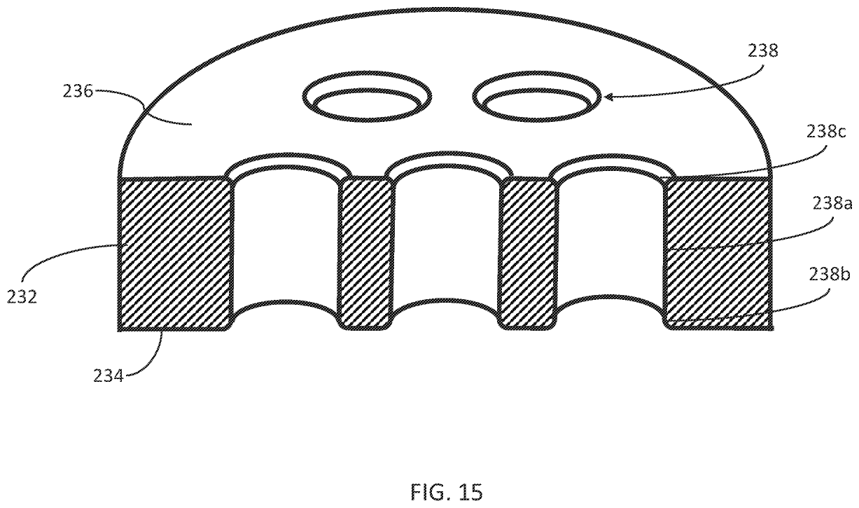

Referring to FIGS. 14-15, the insert 232 includes one or more through holes 238 that extend from top surface 236 of the insert 232 through the insert 232 to the bottom surface 234 of the insert 232. Through holes 238 may include an internal sidewall 238a defining, at least partially, a cavity for receiving feed material (e.g., feed material 126). The internal sidewall 238a of the through holes 238 may include a cross section of various shapes (e.g., circular, hexagonal, pentagonal, star-shaped, triangular, square, arcuate, or rectangular). In some embodiments, the internal sidewall 238a includes a taper forming a conical or frustoconical shape. Through holes 238 include a bottom edge 238b and a top edge 238c. The bottom edge 238b and top edge 238c may include one or more geometric features (e.g., a fillet or a chamfer).

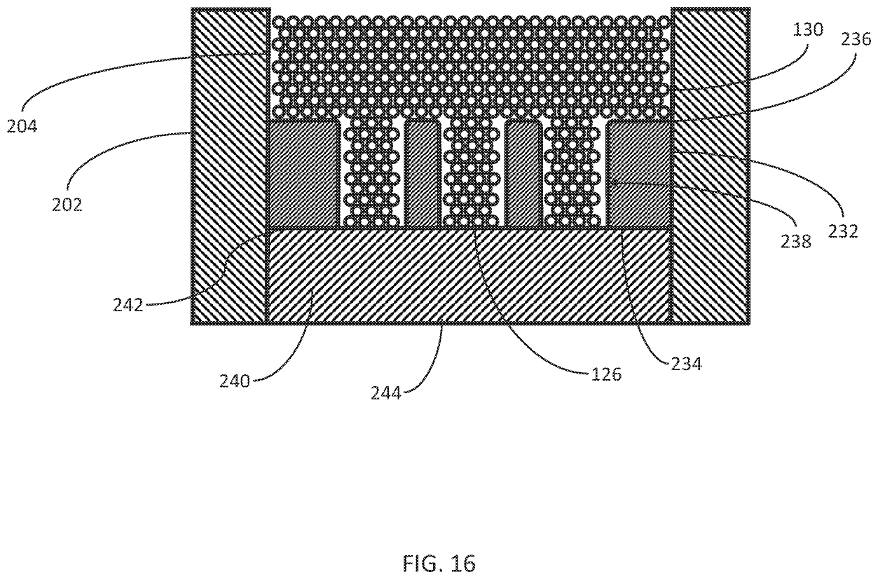

FIG. 16 is an elevational cross-sectional view of the die 202, spacer 240, and insert 232 taken along reference line 16 of FIG. 13. The through hole 238 of the insert 232 together with the top surface 242 of the spacer 240 define one or more first cavities for receiving a feed material (e.g., feed material 126). An interior surface 304 of the die 302 together with the top surface 236 of the insert 332 at least partially defines a second cavity for receiving a filler material (e.g., filler material 130). Once deposited in the cavity, the feed material 126, the filler material 130, and the die assembly 201 may be subjected to a sintering process to form a sintered array (e.g., sintered array 120) or discrete sintered articles (e.g., discrete sintered articles 134).

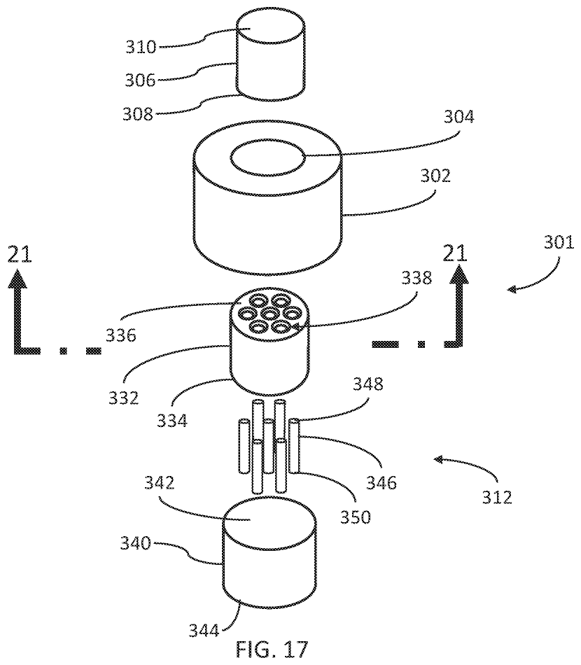

An exploded view of a die assembly 301 is shown in FIG. 17. The die assembly 301 includes a lower punch 312 including a spacer 340 and an insert 332 having through holes 338 formed therethrough. The through holes 338 may be configured to receive a plunger 346 within the through hole 338. The plunger 346 includes a top surface 348 which, together with an internal sidewall 338a of the through hole 338 defines one or more cavities for receiving a feed material (e.g., feed material 126) to be formed into a sintered material (e.g., sintered array 120) or discrete sintered articles (e.g., discrete sintered article 134).

Die assembly 301 includes a die 302, an upper punch 306, and a lower punch 312 including spacer 340 and insert 332. The die 302 includes an interior surface 304 partially defining a cavity for receiving a feed material (e.g., feed material 126) and/or filler material (e.g., filler material 130). The upper punch 306 includes a top surface 310 configured to interface with an SPS tooling assembly (e.g., SPS tooling assembly 100) and a bottom surface 308 partially defining a cavity for receiving a feed material (e.g., feed material 126) and/or filler material (e.g., filler material 130). The spacer 340 includes a bottom surface 344 configured to interface with an SPS tooling assembly (e.g., SPS tooling assembly 100), and a top surface 342. The spacer 340 may include a recess formed in the top surface 342 of the spacer 340 and configured to receive a portion of the insert 332 therein.

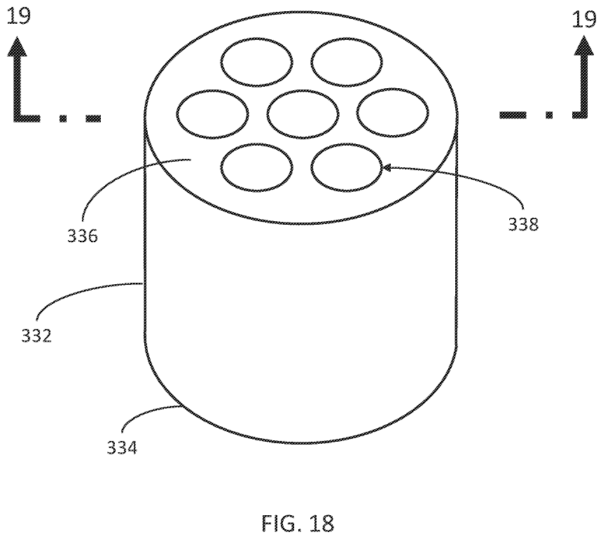

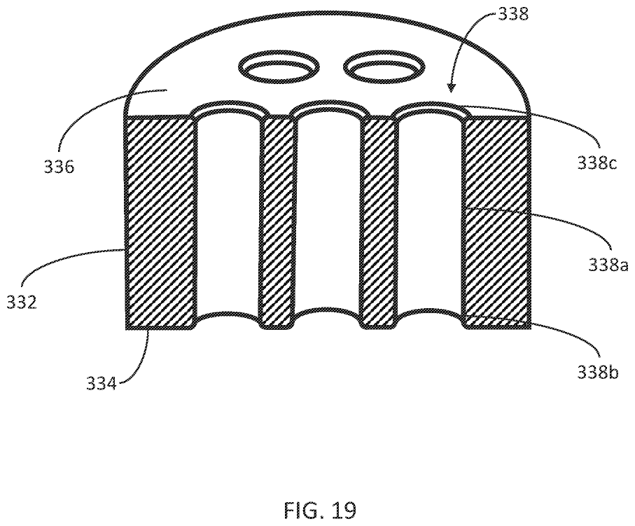

FIG. 18 provides a perspective view of the insert 332, and FIG. 19 provides a cross-sectional perspective view of the insert 332 of FIG. 18 along reference line 19. The insert 332 includes one or more through holes 338. Through holes 338 extend from a top surface 336 of the insert 332 through the insert 332 to a bottom surface 334 of the insert 332. Through holes 338 may include an internal sidewall 338a defining, at least partially, one or more cavities configured to receive a feed material (e.g., feed material 126). The internal sidewall 338a of the through holes 338 may include a cross section of various shapes (e.g., circular, hexagonal, pentagonal, star-shaped, triangular, square, arcuate, or rectangular). In some embodiments, the internal sidewall 338a includes a taper forming a conical or frustoconical shape. Through holes 338 also include a bottom edge 338b and a top edge 338c. The bottom edge 338b and top edge 338c may include one or more geometric features (e.g., a fillet or a chamfer). For example, the top edge 338c may include a chamfer or a fillet to facilitate easier loading of the feed material (e.g., feed material 126) into the through hole 338, easier removal of the sintered material (e.g., sintered array 120) or discrete sintered articles (e.g., discrete sintered article 134), and provide increased strength of sintered material (e.g., sintered array 120) or discrete sintered articles (e.g., discrete sintered article 134).

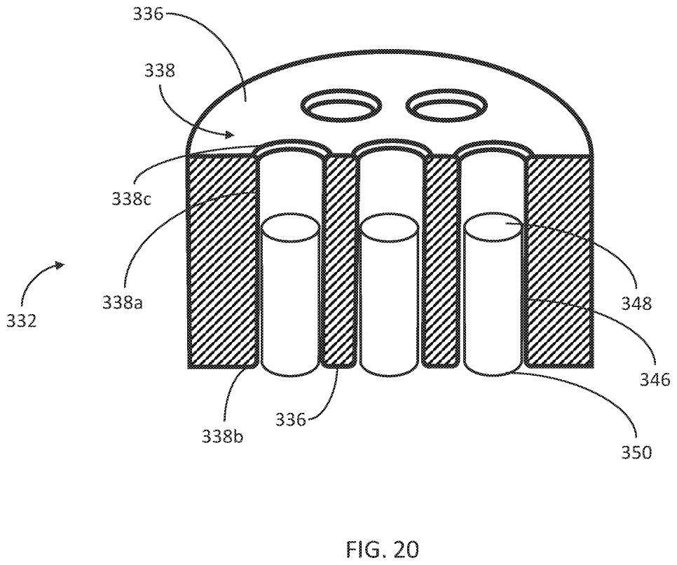

FIG. 20 provides a cross-sectional perspective view of the insert 332 of FIG. 18 along reference line 19 with plungers 346 positioned within the through holes 338. The plungers 346 include a bottom surface 350 configured to contact a top surface 342 of the spacer 340. The plungers 346 may include a substantially circular cross section. In other embodiments the plungers 346 may include a cross section of various shapes (e.g., hexagonal, pentagonal, star-shaped, triangular, square, arcuate, or rectangular). In some embodiments, the plungers 346 include a tapered outer surface forming a conical or frustoconical shape. The plungers 346 may include a feature extending from the top surface 348 of the plungers 346. The feature may include a protrusion extending upward into the one or more cavities defined by the plungers 346 and the internal sidewall 338a (e.g., to form a depression in the resulting sintered article). In some embodiments the feature is configured as a recess extending downward from the top surface 348 (e.g., to form a protrusion on the resulting sintered article). The feature may include a cross section of various shapes (e.g., circular, hexagonal, pentagonal, star-shaped, triangular, square, arcuate, or rectangular). In some embodiments, the cross-sectional shape of the feature is substantially similar to a cross-sectional shape of the internal sidewall 338a. In other embodiments, the cross-sectional shape of the feature differs from the cross-sectional shape of the internal sidewall 338a. Plungers 346 of various heights, shapes, and sizes may be used simultaneously in the through holes 338 of the insert 332 to produce sintered arrays (e.g., sintered array 120) and discrete sintered articles (e.g., discrete sintered article 134) with different shapes, sizes, and dimensions in a single sintering process. Therefore, sintered articles 124 of different shapes, sizes, and dimensions may be substantially simultaneously formed. The plungers 346 may be easily removed following the sintering process by applying pressure to a back surface of the plungers 346, which also facilitates easy removal of the sintered articles 124. Since the plungers 346 are removable, one or more damaged plungers 346 may be easily replaced without replacing all of the plungers 346.

The top surface 348 of the plungers 346 together with the internal sidewall 338a of the through hole 338 defines one or more cavities configured to receive a feed material (e.g., feed material 126) for forming one or more sintered articles (e.g., sintered articles 124).

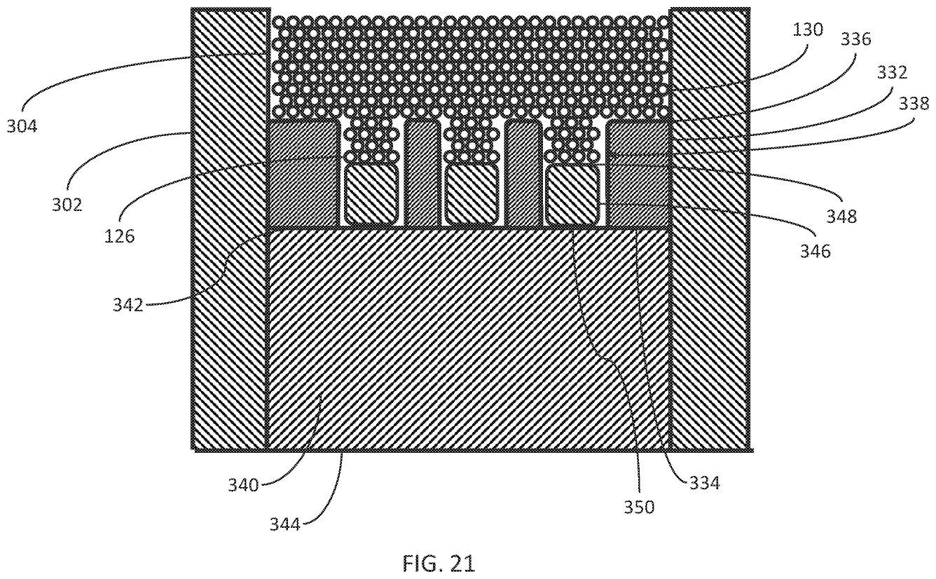

FIG. 21 is an elevational cross-sectional view of the die 302, spacer 240, and insert 232 taken along reference line 21 of FIG. 17. The through hole 338 of the insert 332 together with the top surface 348 of the plunger 346 define one or more cavities for receiving a feed material (e.g., feed material 126). An interior surface 304 of the die 302 together with the top surface 336 of the insert 332 at least partially defines a second cavity for receiving a filler material (e.g., filler material 130). Once deposited in the cavity, the feed material 126, the filler material 130, and the die assembly 301 may be subjected to a sintering process to form a sintered array (e.g., sintered array 120) or discrete sintered articles (e.g., discrete sintered article 134).

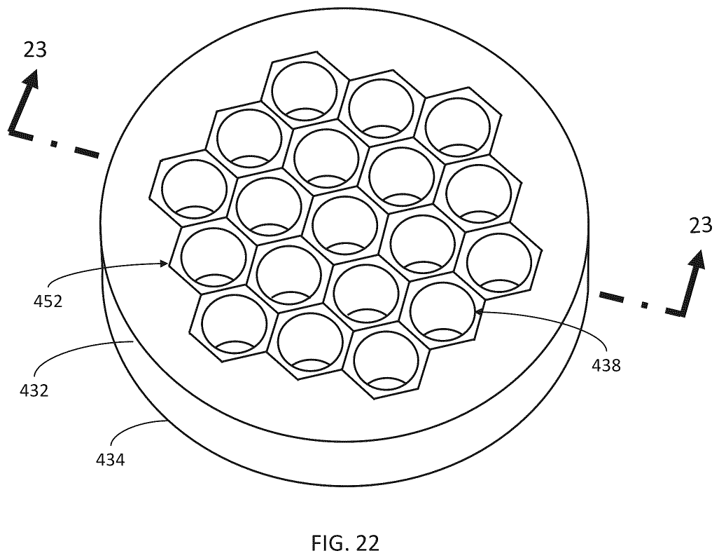

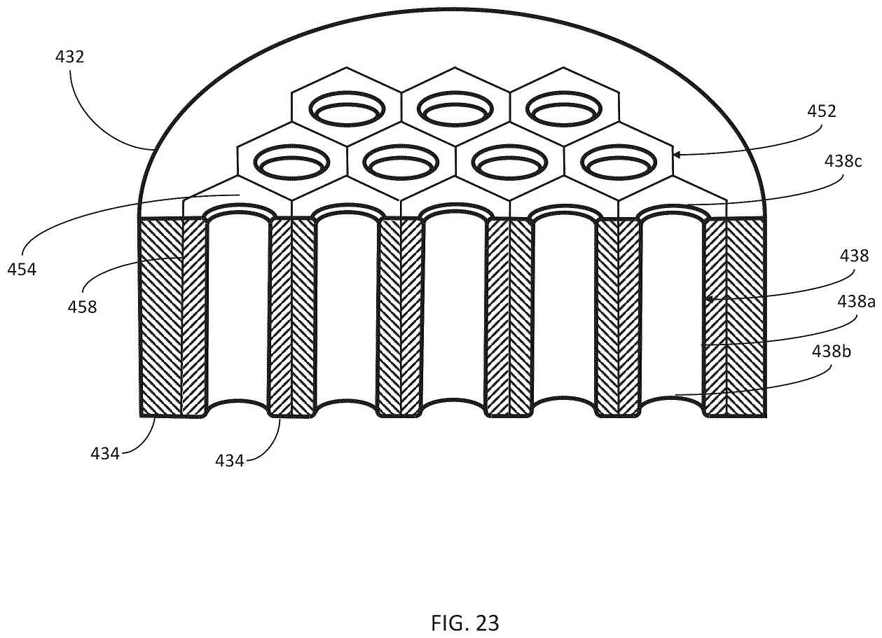

An insert 432 having one or more removable center components 452 is shown in FIGS. 22-23. Referring to FIG. 22, a perspective view of insert 432 is shown. Insert 432 may be used in conjunction with a die assembly (e.g., die assembly 201, 301). The insert 432 may be configured as a consumable article to be used for only a desired number of sintering processes (e.g., 1 process, 5 processes, 10 processes, or greater than 10 processes). Upon depletion of the insert 432, a new insert 432 may be provided without replacing the other components of the die assembly (e.g., die assembly 201, 301).

The insert 432 includes one or more removable center components 452. The center components 452 may include through holes 438. In some embodiments, the removable center components 452 do not include through holes, but include cavities formed therein with a bottom surface of the cavity defined by the center component 452. Through holes 438 extend from a top surface 454 of the center component 452 to a bottom surface 434 of the center component 452. Through holes 438 may include an internal sidewall 438a defining, at least partially, a cavity for receiving feed material (e.g., feed material 126). The internal sidewall 438a of the through holes 438 may include a substantially circular cross section. The internal sidewall 438a may include a cross section of various shapes (e.g., circular, hexagonal, pentagonal, star-shaped, triangular, square, arcuate, or rectangular). In some embodiments, the internal sidewall 438a includes a taper forming a conical or frustoconical shape. Through holes 438 include a bottom edge 438b and a top edge 438c. The bottom edge 438b and top edge 438c may include one or more geometric features (e.g., a fillet or a chamfer). For example, the top edge 438c may include a chamfer or a fillet to facilitate easier loading of the feed material (e.g., feed material 126) into the through hole 438, easier removal of the sintered material (e.g., sintered array 120), and provide increased strength for resulting sintered articles 124.

The center component 452 includes at least one outer sidewall 458. The outer sidewall 458 of the center component 452 may have a substantially hexagonal cross-sectional shape and be configured to contact outer sidewalls 458 of other center components 452 when positioned within the insert 432. In other embodiments, the cross section of the outer sidewall 458 could have a variety of shapes (e.g., circular, hexagonal, square, or rectangular) and be configured to contact outer sidewalls 458 of other center components 452 when positioned within the insert 432.

Using SPS processes, according to embodiments of the disclosure, may utilize far fewer acts and lower costs compared to conventional processes. For example, compared to conventional processes, the SPS processes of embodiments of the disclosure may facilitate improved compositional control, high material efficiency (e.g., reduced material waste), high dimensional accuracy, and increased synthesis speed (e.g., facilitating a greater throughput over a given time period).

While the disclosed methods and apparatus are susceptible to various modifications and alternative forms in implementation thereof, specific embodiments have been shown by way of example in the drawings and have been described in detail herein. However, it should be understood that the present disclosure is not intended to be limited to the particular forms disclosed. Rather, the present disclosure encompasses all modifications, combinations, equivalents, variations, and alternatives falling within the scope of the present disclosure as defined by the following appended claims and their legal equivalents.

1. A method of forming an article, comprising:
placing a feed material having a first sintering temperature in one or more cavities of a die assembly of a sintering apparatus;
placing a filler material having a second sintering temperature in at least one of the one or more cavities of the die assembly of the sintering apparatus; and
applying a heat and a pressure across the feed material and the filler material to form one or more sintered articles comprising the feed material.

2. The method of claim 1, wherein the die assembly comprises:
an upper punch;
a lower punch wherein the one or more cavities are defined by one of the upper punch and the lower punch; and
a die comprising a through hole configured to at least partially receive the upper punch and the lower punch.

3. The method of claim 2, wherein placing the feed material in the die assembly comprises:
placing the feed material in a first cavity of the one or more cavities; and
placing the filler material in a second cavity of the one or more cavities, the second cavity defined at least partially by the die and at least one of the lower punch and the upper punch.

4. The method of claim 1,
wherein the second sintering temperature of the filler material is higher than the first sintering temperature of the feed material; and
wherein applying the heat and the pressure across the feed material and the filler material comprises heating the feed material and the filler material to a temperature higher than the first sintering temperature of the feed material and lower than the second sintering temperature of the filler material.

5. The method of claim 4, wherein heating the feed material and the filler material comprises sintering the feed material without sintering the filler material.

6. The method of claim 4, wherein forming the one or more sintered articles comprising the feed material comprises forming a plurality of discrete sintered articles.

7. The method of claim 1, wherein the second sintering temperature of the filler material is substantially similar to the first sintering temperature of the feed material; and
wherein applying the heat and the pressure across the feed material and the filler material comprises:
heating the feed material and the filler material to a temperature higher than the first sintering temperature of the feed material and higher than the second sintering temperature of the filler material; and
sintering the feed material together with the filler material.

8. The method of claim 1, further comprising placing a release agent in the die assembly.

9. The method of claim 1, further comprising placing a liner in the die assembly.

10. A die assembly of a sintering apparatus comprising:
an upper punch;
a lower punch comprising an insert defining one or more first through holes and a spacer wherein the one or more first through holes and an upper surface of the spacer define one or more first cavities configured to receive a feed material; and
a die defining a second through hole configured to at least partially receive the upper punch and the lower punch, the second through hole and at least one of the upper punch and the lower punch defining a second cavity configured to receive a filler material.

11. The die assembly of claim 10, further comprising one or more plungers configured to be positioned within the one or more first through holes.

12. The die assembly of claim 11, wherein a top surface of the one or more plungers and an interior sidewall of the one or more first through holes together define the one or more first cavities.

13. The die assembly of claim 11, wherein the one or more plungers comprises a first plunger with a first height and a second plunger with a second height wherein the first height differs from the second height.

14. The die assembly of claim 10, wherein the insert comprises one or more removable center components defining the one or more first through holes.

15. The die assembly of claim 14, wherein the one or more removable center components comprise an outer sidewall with a hexagonal cross-sectional shape.

16. A die assembly of a sintering apparatus comprising:
a lower punch;
an upper punch, at least one of the lower punch and the upper punch including one or more features defining one or more first cavities configured to receive a feed material; and
a die defining a through hole configured to at least partially receive the lower punch and the upper punch, the lower punch, the upper punch, and the die together defining a second cavity configured to receive a filler material.

17. The die assembly of claim 16, wherein the one or more features comprise a bottom surface spaced a predetermined distance from a top surface of the lower punch.

18. The die assembly of claim 17, wherein the one or more features comprise an internal feature extending from the bottom surface.

19. The die assembly of claim 16, wherein the lower punch comprises one or more removable center components comprising the one or more features.

20. The die assembly of claim 16, wherein the one or more first cavities comprise a frustoconical shape.
